(19) United States
(12) Patent Application Publication
(10) Pub. No.: US 2022/0227958 A1
(43) Pub. Date: Jul. 21, 2022

(54) FILTER HOUSING AND FILTER COMPRISING SAME

(71) Applicant: TOHO KASEI CO., LTD., Nara (JP)

(72) Inventors: Hirotaka ITAMI, Nara (JP); Norio MAEDA, Nara (JP)

(21) Appl. No.: 17/609,516

(22) PCT Filed: Apr. 3, 2020
(86) PCT No.: PCT/JP2020/015395

§ 371 Date: Nov. 8, 2021

(30) Foreign Application Priority Data
May 10, 2019 (JP) 2019-090170

(51) Int. Cl. C08K 3/04; B01D 35/30; B01D 46/50; B29B 7/90; B29C 43/00; B29C 43/52

(52) U.S. Cl. CPC C08K 3/041; B01D 35/308; B01D 46/50; B29B 7/90; B29K 2027/18; B29C 43/52; C08K 2201/001; C08K 2201/011; B01D 2201/50; B29C 43/003

(57) ABSTRACT

Disclosed is a filter housing which is a molded body of a fluororesin composition in which carbon nanotubes are dispersed in a fluororesin, wherein the fluororesin composition comprises 0.01 to 2.0% by mass of the carbon nanotubes.

### TECHNICAL FIELD

The present invention relates to a filter housing and a filter comprising the same, and more particularly to a filter housing which has excellent antistatic performance and exhibits excellent static eliminating performance while preventing elution of impurities (metal ions, organic substances, etc.) and a filter comprising the same.

### BACKGROUND ART

Fluororesins are often used as materials for a filter housing and a filter comprising the same because of their excellent chemical resistance and contamination resistance.

However, since the fluororesins are commonly classified as insulating materials, when the filter housing produced by using the fluororesins comes into contact with fluid, electrostatic charge may occur due to friction.

It is known that conductive substances such as carbon black and iron powder are mixed with the fluororesin to impart conductivity to the fluororesin, and that the conductive substances come into contact with fluid, so that metal ions, organic substances and the like are eluted into the fluid, leading to contamination of the fluid.

Patent Literature 1 discloses a polymer mixture which includes at least two kinds of conductive additives and provides both surface conductivity and internal conductivity without significantly affecting physical properties of the polymer, and a conductive molded article formed from the polymer mixture. Patent Literature 1 discloses that the polymer can be a fluoropolymer, the conductive additive can include carbon particles, and the conductive molded article can be a fuel filter housing (see Patent Literature 1, Claims, [0001]).

Patent Literature 2 provides a filter unit used in purification for obtaining a chemical solution having excellent defect suppression performance during producing a semiconductor device, and a chemical solution purification apparatus provided with the filter unit (see Patent Literature 2, [0001], [0006], [0009]). The filter unit of Patent Literature 2 includes a first filter provided with a filter medium including a first polymer having a specific chemical structure, and a second filter provided with a filter medium including a second polymer having a specific chemical structure (see Patent Literature 2, [Claim 1]). Patent Literature 2 also discloses a static eliminating method in which a chemical solution containing an organic solvent is brought into contact with a conductive material and exemplifies, as the conductive material, stainless steel, gold, platinum, diamond and glassy carbon (see Patent Literature 2, [0115]).

### CITATION LIST

### Patent Literature

Patent Literature 1: JP 2004-534353 A

Patent Literature 2: WO 2019/013155

### SUMMARY OF THE INVENTION

### Technical Problem

Although the filter housing of Patent Literature 1 can achieve antistatic performance since the fluid comes into contact with the conductive substance, there is a problem that fluid contamination may occur. However, since the filter housing is a fuel filter housing, Patent Literature 1 never mentions a problem that contamination can occur.

In recent years, in addition to “antistatic” of the fluid and “contamination prevention” of the fluid, “static elimination” of already charged fluid is also required. Herein, the term “antistatic” means that static electricity is prevented from being generated and charged in an uncharged electrically insulating material, while the term “static elimination” means that static electricity is removed from an electrically insulating material which is already charged with the static electricity, namely, they differ in this respect.

Thus, it is an object of the present invention to provide a filter housing which has excellent antistatic performance and exhibits excellent static eliminating performance while preventing elution of impurities (metal ions, organic substances, etc.), and a filter comprising the same.

### SOLUTION TO PROBLEM

The present inventors have intensively studied and found that, when using a fluororesin composition in which a specific amount of carbon nanotubes are dispersed in a fluororesin, it is possible to obtain a filter housing which has excellent antistatic performance and exhibits excellent static eliminating performance while preventing elution of impurities (metal ions, organic substances, etc.). They have also found that such filter housing can be suitably used in a filtration apparatus, and thus the present invention has been completed.

The present specification includes the following embodiments.

[1] A filter housing which is a molded body (or molded article) of a fluororesin composition in which carbon nanotubes are dispersed in a fluororesin,

wherein the fluororesin composition comprises 0.01 to 2.0% by mass of the carbon nanotubes.

[2] The filter housing according to aforementioned 1, wherein the carbon nanotubes have an average length of 40 μm or more.
[3] The filter housing according to aforementioned 1 or 2, which has a volume resistivity of 1×10⁻¹ to 1×10⁶ Ω·cm.
[4] The filter housing according to any one of aforementioned 1 to 3, wherein the fluororesin comprises at least one selected from polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), ethylene/chlorotrifluoroethylene copolymer (ECTFE), polychlorotrifluoroethylene (PCTFE), polyvinylidene fluoride (PVDF) and polyvinyl fluoride (PVF).
[5] The filter housing according to any one of aforementioned 1 to 4, wherein the fluororesin of the fluororesin composition has an average particle size of 500 μm or less.
[6] A filter comprising the filter housing according to any one of aforementioned 1 to 5.
[7] A filtration apparatus comprising the filter housing according to any one of aforementioned 1 to 5.
[8] A semiconductor manufacturing apparatus, a liquid crystal manufacturing apparatus, a pharmaceutical manufacturing apparatus, a pharmaceutical delivery apparatus, a chemical manufacturing apparatus or a chemical delivery apparatus, each comprising the filtration apparatus according to aforementioned 7.
[9] A method for producing the filter housing according to any one of aforementioned 1 to 5, comprising compression-molding a fluororesin composition in which carbon nanotubes are dispersed in a fluororesin.
[10] A method for producing the filter housing according to any one of aforementioned 1 to 5, comprising:

preparing a fluororesin composition in which carbon nanotubes are dispersed in a fluororesin selected from PTFE and modified PTFE;

placing the fluororesin composition in a mold, pressurizing and compressing the fluororesin composition to produce a pre-molded body;

calcining the pre-molded body at a temperature equal to or higher than a melting point of the fluororesin composition to produce a molded body; and

processing the molded body to produce a filter housing.

[11] A method for producing the filter housing according to any one of aforementioned 1 to 5, comprising:

preparing a fluororesin composition in which carbon nanotubes are dispersed in a fluororesin other than PTFE and modified PTFE;

heating the fluororesin composition, pressurizing and compressing the fluororesin composition to obtain a molded body; and

processing the molded body to obtain a filter housing.

### Advantageous Effects

The filter housing and the filter including the same according to the embodiment of the present invention have excellent antistatic performance and exhibit excellent static eliminating performance while preventing elution of impurities (metal ions, organic substances, etc.). Therefore, they can be suitably used in a filter (or filtration) apparatus.

### BRIEF DESCRIPTION OF DRAWINGS

FIG. 1 schematically shows a charge residual ratio measuring apparatus.

### DESCRIPTION OF EMBODIMENTS

The present invention provides a novel filter housing, which is a filter housing that is a molded body (molded article) of a fluororesin composition in which carbon nanotubes are dispersed in a fluororesin,

wherein the fluororesin composition comprises 0.01 to 2.0% by mass of the carbon nanotubes.

As used herein, the term “filter housing” refers to a container for installing a filter element (or filter medium) for filtering and purifying fluid (for example, conductive fluid and non-conductive fluid), and preferably non-conductive fluid (for example, petroleum, hydrocarbon liquid, various oils such as silicon oil, various gases such as air and nitrogen gas, pure water, etc., hereinafter the same shall be applied), and its shape and size are not particularly limited as long as the filter element is installed and a filter can be formed.

The filter housing according to the embodiment of the present invention is a molded body (or molded article) of a fluororesin composition in which carbon nanotubes are dispersed in a fluororesin. The filter housing according to the embodiment of the present invention is made of a fluororesin composition in which carbon nanotubes are dispersed in a fluororesin, and may be formed from the fluororesin composition or may be molded.

As used herein, the term “fluororesin composition” includes a fluororesin and carbon nanotubes, and may include other components as necessary, and is not particularly limited as long as the objective filter housing of the present invention can be obtained.

As used herein, the term “fluororesin” is a resin usually understood as a fluororesin, and is not particularly limited as long as the objective filter housing of the present invention can be obtained.

Examples of the fluororesin include at least one selected from polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), ethylene/chlorotrifluoroethylene copolymer (ECTFE), polychlorotrifluoroethylene (PCTFE), polyvinylidene fluoride (PVDF) and polyvinyl fluoride (PVF).

The fluororesin is preferably polytetrafluoroethylene (PTFE), modified polytetrafluoroethylene (modified PTFE), tetrafluoroethylene/perfluoroalkyl vinyl ether copolymer (PFA), tetrafluoroethylene/hexafluoropropylene copolymer (FEP), ethylene/tetrafluoroethylene copolymer (ETFE), polychlorotrifluoroethylene (PCTFE) or polyvinylidene fluoride (PVDF), and more preferably polytetrafluoroethylene (PTFE), modified polytetrafluoroethylene (modified PTFE), tetrafluoroethylene/perfluoroalkyl vinyl ether copolymer (PFA) or polychlorotrifluoroethylene (PCTFE).

It is possible to use, as the fluororesin, commercially available products. Examples thereof include:

POLYFLON (registered trademark) PTFE-M (trade name) M-12, M-11 manufactured by Daikin Industries, Ltd. as polytetrafluoroethylene (PTFE);

POLYFLON (registered trademark) PTFE-M (trade name) M-112, M-111 manufactured by Daikin Industries, Ltd. as modified polytetrafluoroethylene (modified PTFE);

NEOFLON (registered trademark) PCTFE (trade name) M-300PL, M-300H manufactured by Daikin Industries, Ltd. as polychlorotrifluoroethylene (PCTFE); and

NEOFLON (registered trademark) PFA (trade name) AP-230, AP-210 manufactured by Daikin Industries, Ltd. as tetrafluoroethylene/perfluoroalkyl vinyl ether (PFA).

These fluororesins can be used alone or in combination thereof.

In the embodiment of the present invention, the fluororesin of the fluororesin composition is in a form of particles, and has an average particle size of preferably 500 μm or less, more preferably 8 to 250 μm, still more preferably 10 to 50 μm, and particularly preferably 10 to 25 μm.

When the fluororesin of the fluororesin composition has an average particle size of 500 μm or less, the fluororesin and carbon nanotubes can be more uniformly mixed, leading to a further improvement in conductivity.

As used herein, the term “average particle size of particles” refers to an average particle size D₅₀ (median diameter which means a particle size at 50% of a cumulative value in the particle size distribution determined by a laser diffraction scattering method) obtained by measuring the particle size distribution using a laser diffraction/scattering particle size distribution analyzer (“MT3300II”, manufactured by Nikkiso Co., Ltd.).

As used herein, the term “carbon nanotubes” are substances usually understood as carbon nanotubes, and are not particularly limited as long as the objective filter housing of the present invention can be obtained.

Examples of such carbon nanotubes (also referred to as “CNTs”) include single wall (or layer) CNT, multi wall CNT, double wall CNT and the like. Commercially available products can be used as the carbon nanotubes, for example, CNT-uni (trade name) series manufactured by TAIYO NIPPON SANSO CORPORATION can be used.

These CNTs can be used alone or in combination.

In the embodiment of the present invention, the carbon nanotubes preferably have an average length of 40 μm or more, more preferably 40 to 600 μm, still more preferably 50 to 500 μm, and particularly preferably 100 to 450 μm.

When the CNTs have an average length of 40 μm or more, it is preferable that the conductive path is easily connected, leading to a further improvement in conductivity.

As used herein, the term “average length (or average fiber length) of CNTs” refers to an average length obtained from images taken by SEM, as described in detail in Examples. In other words, a portion of the filter housing is heated to 300° C. to 600° C. to be ashed, thus obtaining a residue (a sample for SEM imaging). SEM images of the residue are taken. The length of each of carbon nanotubes in the SEM images is determined by image processing. The average of the lengths obtained by the image processing is determined by calculation, and the average is regarded as the average length of the CNTs.

In the embodiment of the present invention, the fluororesin composition includes 0.01 to 2.0% by mass, preferably 0.04 to 1.5% by mass, more preferably 0.05 to 1.0% by mass, and particularly preferably 0.05 to 0.5% by mass, of the carbon nanotubes based on the fluororesin composition (100% by mass).

When the fluororesin composition includes 0.01 to 2.0% by mass of the carbon nanotubes, the amount is large enough to form a conductive path, so that it is more economical while further securing the conductivity, which is preferable.

The filter housing according to the embodiment of the present invention has a volume resistivity of preferably 1×10⁷ Ω·cm or less, more preferably 1×10⁶ Ω·cm or less, still more preferably 1×10³ Ω·cm or less, and particularly preferably 1×10³ Ω·cm or less.

The filter housing according to the embodiment of the present invention may have a volume resistivity of 1×10⁻¹ Ω·cm or more, 1×10⁰ Ω·cm or more, and 1×10¹ Ω·cm or more.

The measurement of the volume resistivity was mentioned in Examples.

Regarding the filter housing according to the embodiment of the present invention, resistance of 10 cm in length is preferably 1×10⁶ Ω or less, more preferably 8×10⁵ Ω or less, still more preferably 5×10⁵ Ω or less, and particularly preferably 1×10⁵ Ω or less.

When the resistance of 10 cm in length is 1×10⁶ Ω or less, electric conduction is sufficiently secured, so that fluid static eliminating properties are further improved (charge residual ratio is further degraded), which is preferable.

When the filter housing according to the embodiment of the present invention is used, the charge residual ratio of pure water which has passed through the filter is preferably 70% or less, more preferably 50% or less, still more preferably 30% or less, and particularly preferably 20% or less, as evaluated by using the method mentioned in Examples.

When the charge residual ratio is 70% or less, static electricity is suppressed, so that non-dust collecting performance of the fluid (preferably non-conductive fluid) which has passed through the filter is further improved, which is preferable.

Regarding the filter housing according to the embodiment of the present invention, discharge craters are preferably 5 or less, and more preferably, no discharge craters are observed as evaluated by using the method mentioned in Examples.

When the discharge craters are 5 or less, troubles associated with the discharge can be further suppressed, which is preferable.

With respect to the filter housing according to the embodiment of the present invention, when contamination resistance is evaluated by the method mentioned in Examples herein, each amount of Al, Cr, Cu, Fe, Ni and Zn detected is preferably less than 5 ppb, each amount of Al, Cr, Cu, Fe, Ni, Zn, Ca, K and Na is more preferably less than 5 ppb, each amount of all metals detected is more preferably less than 5 ppb, still more preferably less than 1 ppb, and particularly preferably less than 0.5 ppb.

An amount of the total organic carbon eluted is preferably less than 50 ppb, more preferably less than 40 ppb, and still more preferably less than 30 ppb.

The filter housing according to the embodiment of the present invention can have various sizes depending on the intended application, and there is no particular limitation on size as long as the objective filter housing of the present invention can be obtained.

The filter housing has, for example, a cylindrical (or tubular) shape, can have an outer diameter of, for example, 4 to 500 mm, 6 to 250 mm, 6 to 75 mm, or 6 to 50 mm, and can have a wall thickness of, for example, 0.5 to 50 mm, 1 to 30 mm, 1 to 20 mm, or 2 to 10 mm.

The filter housing according to the embodiment of the present invention may be produced using any method as long as the objective filter housing of the present invention can be obtained.

The filter housing according to the embodiment of the present invention is preferably produced by a production method including compression-molding a fluororesin composition in which carbon nanotubes are dispersed in a fluororesin.

With regard to the method for producing the filter housing according to the embodiment of the invention, a method for producing a filter housing for PTFE and modified PTFE is partially different from a method for producing a filter housing for other fluororesins (for example, PFA, FEP, ETFE, ECTFE, PCTFE, PVDF and PVF).

The method for producing a filter housing for PTFE and modified PTFE includes: preparing a fluororesin composition in which carbon nanotubes are dispersed in a fluororesin (preferably particulate fluororesin); (after performing an appropriate pre-treatment (pre-drying, granulation, etc.) as necessary,) placing the fluororesin composition in a mold, pressurizing under a pressure of preferably 0.1 to 100 MPa, more preferably 1 to 80 MPa, and still more preferably 5 to 50 MPa, and compressing the fluororesin composition to produce a pre-molded body; calcining the pre-molded body at a temperature equal to or higher than the melting point (temperature of preferably 345 to 400° C., and more preferably 360 to 390° C.) of the fluororesin composition for preferably 2 hours or more to produce a molded body; and processing (preferably cutting) the molded body to produce a filter housing.

The method for producing a filter housing for fluororesins other than PTFE and modified PTFE (for example, PFA, FEP, ETFE, ECTFE, PCTFE, PVDF and PVF) includes: preparing a fluororesin composition in which carbon nanotubes are dispersed in a fluororesin (preferably particulate fluororesin); placing the fluororesin composition in a mold, and after performing an appropriate pre-treatment (pre-drying, etc.) as necessary, for example, heating at a temperature of 150 to 400⁰0 for 1 to 5 hours, compressing the fluororesin composition under a pressure, for example, 0.1 to 100 MPa (preferably 1 to 80 MPa, and more preferably 5 to 50 MPa) to obtain a pre-molded body; and processing (preferably cutting) the molded body to obtain a filter housing.

The present invention can provide a filter (or filter cassette) including the filter housing and filter element (or filter medium) according to the present embodiment. The filter element is not particularly limited as long as the filter housing of the present embodiment can be used.

In the embodiment of the present invention, the filter element can include carbon nanotubes in at least a part thereof. It is possible to appropriately select the content of the carbon nanotubes, the material of the filter element, the form, shape and size of the filter element. The material of the filter element may be, for example, fluororesins; olefin-based resins such as polyethylene or polypropylene; polyamide-based resin such as nylon; polystyrene-based resins such as polystyrene; or polyester-based resins such as polyethylene terephthalate. The form, shape, size and the like of the filter element can be appropriately selected. The filter element may be formed from, for example, a resin composition including carbon nanotubes (for example, resin compositions such as fluororesin compositions, olefin-based resin compositions, polyamide-based resin compositions, polystyrene-based resin compositions and polyester-based resin compositions). The content of the carbon nanotubes may be, for example, 0.01 to 2.0% by mass based on the resin composition (100% by mass).

When pure water is filtered using the filter according to the embodiment of the present invention, it is possible to produce pure water having a charge residual ratio of preferably 70% or less, more preferably 50% or less, still more preferably 30% or less, and particularly preferably 20% or less, as evaluated by using a method mentioned in Examples.

When the charge residual ratio is 70% or less, the static electricity is suppressed, so that a fluid having further improved non-dust collecting performance can be produced by passing through the filter according to the embodiment of the present invention, which is preferable.

The present invention can provide a filtration apparatus (or filter apparatus) including the filter (or filter cassette) according to the embodiment of the present invention.

The present invention can also provide various facilities including the filtration apparatus, for example, a semiconductor manufacturing apparatus, a liquid crystal manufacturing apparatus, a pharmaceutical manufacturing apparatus, a pharmaceutical delivery apparatus, a chemical manufacturing apparatus and a chemical delivery apparatus.

### EXAMPLES

The present invention will be more specifically described in detail by way of Examples and Comparative Examples. It should be noted, however, each of these Examples is merely an embodiment of the present invention and the present invention is in no way limited thereto.

Components used in these Examples are shown below.

### (A) Fluororesin

(A1) Polychlorotrifluoroethylene (NEOFLON (registered trademark) PCTFE (trade name) manufactured by Daikin Industries, Ltd.) (also referred to as “(A1) PCTFE”)

(A2) Modified polytetrafluoroethylene (POLYFLON (registered trademark) PTFE-M (trade name) manufactured by Daikin Industries, Ltd.) (also referred to as “(A2) modified PTFE”)

(A3) Tetrafluoroethylene/perfluoroalkyl vinyl ether copolymer (NEOFLON (registered trademark) PFA (trade name) manufactured by Daikin Industries, Ltd.) (also referred to as “(A3) PFA”)

### (B) Carbon Nanotubes

(B1) Carbon nanotubes (average fiber length by SEM observation: about 130 μm, CNT-uni (registered trademark) manufactured by TAIYO NIPPON SANSO CORPORATION) (also referred to as “(B1) CNT”)

(B2) Carbon nanotubes (average fiber length: about 400 μm, CNT-uni (registered trademark) manufactured by TAIYO NIPPON SANSO CORPORATION) (also referred to as “(B2) CNT”)

(B3) Carbon nanotubes (average fiber length: about 60 μm, CNT-uni (registered trademark) manufactured by TAIYO NIPPON SANSO CORPORATION) (also referred to as “(B3) CNT”)

(B4)' Carbon nanotubes (average fiber length: about 20 μm, CNT-uni (registered trademark) manufactured by TAIYO NIPPON SANSO CORPORATION) (also referred to as “(B4)' CNT”)

Carbon Fiber-Including Fluororesin

(C1) Carbon fiber-including PTFE (Fluon (registered trademark) PB2515 manufactured by ASAHI GLASS CO., LTD.)

### Example 1

(A1) Polychlorotrifluoroethylene (PCTFE) was ground using a grinder and then classified by a vibrating screening machine to prepare (A1) PCTFE particles. Using a laser diffraction-scattering particle size distribution analyzer (“MT3300II” manufactured by Nikkiso Co., Ltd.), the particle size distribution of the (A1) PCTFE particles was measured to obtain an average particle size (D₅₀) of the (A1) PCTFE particles. The average particle size (D₅₀) of the (A1) PCTFE particles was 11.5 μm.

Next, carbon nanotubes are dispersed and mixed with the thus obtained (A1) PCTFE particles.

To 500 g of a dispersion of (B1) carbon nanotubes containing water as a solvent (dispersant: 0.15% by mass, (B1) carbon nanotubes: 0.1% by mass), 3,500 g of ethanol was added to dilute the dispersion. Furthermore, 1,000 g of the (A1) PCTFE particles were added to prepare a mixed slurry.

The mixed slurry was fed into a pressure-resistant vessel and liquefied carbon dioxide was fed at a feeding rate of 0.03 g/minute relative to 1 mg of a dispersant contained in the mixed slurry in the pressure-resistant vessel, and then the pressure and the temperature were raised until the pressure inside the pressure-resistant vessel became 20 MPa and the temperature became 50° C. While holding the pressure and temperature for 3 hours, carbon dioxide was discharged from the pressure-resistant vessel together with the dispersant and the solvents (water, ethanol) dissolved in carbon dioxide.

The pressure and the temperature in the pressure-resistant vessel were respectively reduced to atmospheric pressure and normal temperature to remove the carbon dioxide in the pressure-resistant vessel, thus obtaining a (A1) PCTFE composition including 0.1% by mass of (B1) carbon nanotubes. Hereinafter, this step is called as a “step for dispersing and mixing carbon nanotubes”.

Using a compression molding method, the (A1) PCTFE composition was molded to obtain a columnar molded body. In other words, the (A1) PCTFE composition was charged in a mold, and as necessary, an appropriate pretreatment (preliminary drying, etc.) was performed. Then, the (A1) PCTFE composition was heated at a temperature of 200° C. or higher for 2 hours or more, and then cooled to normal temperature while compressing the (A1) PCTFE composition under a pressure of 5 MPa or more to obtain a (A1) PCTFE molded body.

The (A1) PCTFE molded body was subjected to cutting to obtain a filter housing of Example 1 as a cylindrical (or tubular) molded body in which one bottom surface was closed. The filter housing of Example 1 had a diameter (outer diameter) of about 110 mm, a wall thickness of about 5 mm and a height of about 110 mm.

### Example 2

Using the same method as in Example 1, except that 0.05% by mass of the (B1) carbon nanotubes were included, a filter housing of Example 2 was produced.

### Example 3

Using the same method as in Example 1, except that the (B1) carbon nanotubes were changed to (B2) carbon nanotubes, a filter housing of Example 3 was produced.

### Example 4

Using the same method as in Example 1, except that the (B1) carbon nanotubes were changed to (B3) carbon nanotubes, a filter housing of Example 4 was produced.

### Example 5

(A2) Modified polytetrafluoroethylene (modified PTFE) is commercially available in a granular form and has an average particle size (D₅₀) of 19.6 μm. Using the same method as in Example 1, the average particle size (D50) of the (A2) modified PTFE particles was measured.

Using the same method as in Example 1, except that the PCTFE particles (A1) were changed to the (A2) modified PTFE particles, (A2) a modified PTFE composition including 0.1% by mass of the (B1) carbon nanotubes were obtained.

Using a compression molding method, the (A2) modified PTFE composition was molded to obtain a columnar molded body. In other words, the (A2) modified PTFE composition was subjected to an appropriate pre-treatment (pre-drying, etc.)

as necessary, and then a given amount of the (A2) modified PTFE composition was uniformly filled into a mold. The (A2) modified PTFE composition was compressed by pressurizing the (A2) modified PTFE composition under 15 MPa, followed by holding for a given period of time to obtain a (A2) modified PTFE pre-molded body. The (A2) modified PTFE pre-molded body was removed from the mold, calcined in a hot air circulation type electric furnace set at 345° C. or higher for 2 hours or more, slowly cooled and then removed from the electric furnace to obtain a (A2) modified PTFE molded body. The (A2) modified PTFE molded body was subjected to cutting to obtain a filter housing of Example 5 as a cylindrical molded body. The filter housing of Example 5 had a diameter (outer diameter) of about 110 mm, a wall thickness of about 5 mm and a height of about 110 mm.

### Example 6

(A3) tetrafluoroethylene/perfluoroalkyl vinyl ether copolymer (PFA) was ground using a grinder and then classified by a vibrating screening machine to prepare (A3) PFA particles. The average particle size (D₅₀) of the (A3) PFA particles was 121.7 μm. The average particle size (D₅₀) of the (A3) PFA particles was measured using the same method as in Example 1.

Using the same method as in Example 1, except that the (A1) PCTFE particles were changed to the (A3) PFA particles, a (A3) PFA composition including 0.1% by mass of the (B1) carbon nanotubes were obtained.

Using a compression molding method, the (A3) PFA composition was molded to obtain a columnar molded body. In other words, the (A3) PFA composition was charged in a mold, and as necessary, an appropriate pretreatment (preliminary drying, etc.) was performed. Then, the (A3) PFA composition was heated at a temperature of 300° C. or higher for 2 hours or more, and then cooled to normal temperature while compressing the (A3) PFA composition under a pressure of 5 MPa or more to obtain a (A3) PFA molded body.

The (A3) PFA molded body was subjected to cutting to obtain a filter housing of Example 6 as a cylindrical (or tubular) molded body. The filter housing of Example 6 had a diameter (outer diameter) of about 110 mm, a wall thickness of about 5 mm and a height of about 110 mm.

### Comparative Example 1

Using the same method as in Example 1, except that (A1) PCTFE particles were directly compression-molded without being subjected to the “step for dispersing and mixing carbon nanotubes”, a (A1) PCTFE molded body including no carbon nanotubes was obtained.

### Comparative Example 2

Using the same method as in Example 1, except that the (B1) carbon nanotubes were changed to the (B4)' carbon nanotubes, a filter housing of Comparative Example 2 was produced.

### Comparative Example 3

(Cl) Carbon fiber-including PTFE (15% by mass of carbon fiber) composition is commercially available in a granular form and has an average particle size (D₅O) of 630 μm. Using the same method as in Example 1, the average particle size (D₅₀) of PTFE composition was measured.

Using a compression molding method, this PTFE composition was molded to obtain a columnar molded body. In other words, the PTFE composition was subjected to an appropriate pre-treatment (pre-drying, etc.) as necessary, and then a given amount of the PTFE composition was uniformly filled into a mold. The PTFE composition was compressed by pressurizing the PTFE composition under 15 MPa, followed by holding for a given period of time to obtain a PTFE pre-molded body. The PTFE pre-molded body was removed from the mold, calcined in a hot air circulation type electric furnace set at 345° C. or higher for 2 hours or more, slowly cooled and then removed from the electric furnace to obtain a PTFE molded body. The PTFE molded body was subjected to cutting to obtain a filter housing of Comparative Example 3 as a cylindrical molded body. The filter housing of Comparative Example 3 had a diameter (outer diameter) of about 110 mm, a wall thickness of about 5 mm and a length of about 110 mm.

### Average Fiber Length

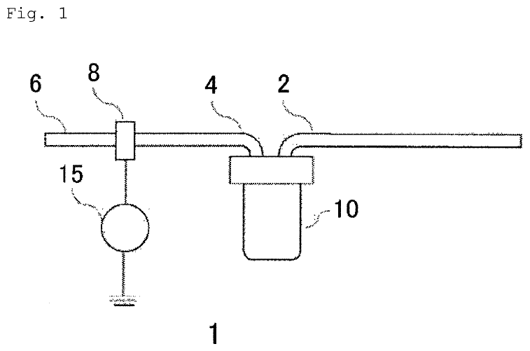

Using a SEM (VE-9800 (trade name) manufactured by KEYENCE CORPORATION), images of a filter housing were taken and then the average fiber length of carbon nanotubes included in the filter housing was evaluated. A portion of the filter housing was ashed (or to be ash) by an ashing method (or calcination method) to fabricate samples for SEM imaging. In other words, a portion of the filter housing was heated to 300° C. to 600° C. to be ashed (or to be ash), thus obtaining a residue. Using the residue as samples for imaging, scanning electron microscope (SEM) observation was performed. For example, SEM images of the filter housing of Example 1 are shown in FIG. 1. The fiber length of fibers of each of carbon nanotubes included in the images was determined by image processing, and then the average of the fiber lengths was determined by calculation. The results are shown in Table 1.

### Static Eliminating Properties based on Resistance Value

Static eliminating properties (or discharge performance) and antistatic properties based on the resistance value were evaluated in accordance with ISO8031:2009. In other words, metal joints were connected to each of both ends of the filter housing. The resistance value between the two metal joints was measured using an insulation resistance meter (3-range insulation resistance meter (trade name) manufactured by Musashi Denki Keiki Seisakusho).

The evaluation criteria for static eliminating properties are as follows.

B: Resistance value between 10 cm is 1×10⁶ Ω or less.

C: Resistance value between 10 cm is more than 1×10⁶ Ω.

The filter housing of Example 1 was evaluated to have satisfactory static eliminating properties. The results are shown in Table 1.

### Contamination Resistance

Measurement of Amount of Metal Eluted from Filter Housing

Degree of metal contamination from the filter housing was evaluated by measuring the amount of metal eluted of 17 metallic elements (Li, Na, Mg, Al, K, Ca, Ti, Cr, Mn, Fe, Co, Ni, Cu, Zn, Ag, Cd and Pb) using an ICP mass spectrometer (“ELAN DRCII” manufactured by PerkinElmer, Inc.). Specimens (10 mm×20 mm×50 mm) were cut out from the cylindrical molded body obtained by compression molding. Each of specimens was immersed in 0.5 L of 3.6% hydrochloric acid (EL-UM grade manufactured by Kanto Chemical Co., Inc.) for about 1 hour, and then washed by sprinkling and running ultrapure water (specific resistance value: ≥18.0 MΩ·cm).

Furthermore, the entire specimen was immersed in 0.1 L of 3.6% hydrochloric acid and then stored in a room temperature environment for 24 hours and 168 hours. After a lapse of the specified time, the entire amount of the immersion solution was collected (by collecting the entire amount of the hydrochloric acid in which the specimen was immersed) and then the concentration of the metal impurities in the immersion solution was analyzed. Three specimens were prepared and a maximum value thereof was regarded as the detection amount.

The evaluation criteria for amount of metal eluted are as follows.

A: The amount of each of all metal detected is less than 5 ppb.

B: The amount of each of Al, Cr, Cu, Fe, Ni, Zn, Ca, K and Na detected is less than 5 ppb.

C: The amount of each of Al, Cr, Cu, Fe, Ni and Zn detected is less than 5 ppb.

D: The amount of any one of Al, Cr, Cu, Fe, Ni and Zn is 5 ppb or more.

The results are shown in Table 1.

Measurement of Carbon Release from Filter Housing

Degree of carbon nanotubes released from the filter housing was evaluated by measuring the total organic carbon

(TOC) using a total organic carbon analyzer (“TOCvwp” manufactured by Shimadzu Corporation). Specifically, each of specimens (10 mm×20 mm×50 mm) cut out from the cylindrical molded body obtained by compression molding was immersed in 0.5 L of 3.6% hydrochloric acid (EL-UM grade manufactured by Kanto Chemical Co., Inc.) for about 1 hour. After immersion for 1 hour, each specimen was washed by sprinkling and running ultrapure water (specific resistance value: ≥18.0 MΩ·cm). Furthermore, the entire specimen was immersed in ultrapure water and then stored in a room temperature environment for 24 hours and 168 hours. After a lapse of the specified time, the entire amount of the immersion solution was collected (by collecting the entire amount of the ultrapure water in which the specimen was immersed) and then the whole organic carbon analysis of the immersion solution was performed. Three specimens were prepared and a maximum value thereof was regarded as the detection amount.

The evaluation criteria are as follows.

B: The amount of total organic carbon detected is less than 50 ppb.

D: The amount of total organic carbon detected is 50 ppb or more.

### Volume Resistivity

Using the same method as in the above-mentioned compression molding method, specimens (φ110×10 mm) were prepared for the respective Examples and Comparative Examples and used as samples for measuring the volume resistivity.

Using a resistivity meter (“Loresta” or “Hiresta” manufactured by Mitsubishi Chemical Analytech Co., Ltd.), the volume resistivity was measured in accordance with JIS K6911.

The evaluation criteria are as follows.

A: The volume resistivity is 1×10³ Ω·cm or less.

B: The volume resistivity is more than 1×10³ Ω·cm and 1×10⁵ Ω·cm or less.

C: The volume resistivity is more than 1×10⁵ Ω·cm and 1×10⁷ Ω·cm or less.

D: The volume resistivity is more than 1×10⁷ Ω·cm.

### Charge Residual Ratio

FIG. 1 schematically shows a charge residual ratio measuring apparatus. The charge residual ratio evaluation apparatus 1 includes a filter 10 to which an IN side tube 2 and an OUT side tube 4 are attached. The filter 10 has a form of a filter cassette and has a filter housing which can include a filter element. The OUT side tube 4 is connected to an OUT side tube 6 via a joint 8, the joint 8 is connected to an electrometer 15, and the electrometer 15 is grounded.

The IN side tube 2 and the OUT side tubes 4 and 6 are made of PFA, and have an outer diameter of 6 mm, an inner diameter of 4 mm and a length of 100 mm.

The filter housing has a cup shape, and has an outer diameter of 110 mm, an inner diameter of 90 mm and a height of 110 mm. As the filter element, Ultipor N66 PUYO1NAEYJ (trade name) (height: 25.4 mm) manufactured by Nihon Pall Ltd. is used, and the filter housings of Examples and Comparative Examples including the filter element are attached as a filter.

The joint 8 is made of PTFE so that even if it comes into contact with fluid in the tube, it does not easily affect evaluation results. As the electrometer 15, an electrometer (Model 6514 (trade name) manufactured by KEYTHLEY) was used.

A pure water piping from a pure water manufacturing apparatus was connected to the IN side PFA piping 2.

An amount of electric charge (Q1) of pure water passed through the joint 8 was measured in a state where the filter (or filter housing) was not connected (state where the IN side tube 2 and the OUT side tube 4 were directly connected by a PFA tube).

Next, the amount of electric charge (Q) of pure water passed through the joint 8 in a state where each filter (or filter housing) was connected was measured.

Pure water was circulated at a flow rate was 2 m/sec for 60 seconds.

Charge residual ratio: (Q/Q1)×100 was determined.

The evaluation criteria are as follows.

A: The charge residual ratio is 30% or less.

B: The charge residual ratio is more than 30% and 50% or less.

C: The charge residual ratio is more than 50% and 70% or less.

D: The charge residual ratio is more than 70%.

### Discharge Craters

Presence or absence of discharge craters was evaluated using the charge residual ratio evaluation apparatus shown in FIG. 1 mentioned above.

In a state where each filter (or filter housing) was connected, pure water was circulated at a flow rate of 3 m/sec for 1 hour.

Thereafter, the presence or absence of discharge craters inside the filter housing was visually observed.

The evaluation criteria are as follows.

B: The number of discharge craters is 0.

C: The number of discharge craters is more than 0 and 5 or less.

D: The number of discharge craters is more than 5.

TABLE 1

| | | | | | | | Comparative | | |
|---|---|---|---|---|---|---|---|---|---|
| | Example | | | | | | Example | | |
| | 1 | 2 | 3 | 4 | 5 | 6 | 1 | 2 | 3 |
| (A) | | | | | | | | | |
| (A1) PCTFE | 100 | 100 | 100 | 100 | | | 100 | 100 | |
| (A2) Modified PTFE | | | | | 100 | | | | |
| (A3) PFA | | | | | | 100 | | | |
| (B) | | | | | | | | | |
| (B1) CNT 150 | 0.1 | 0.05 | | | 0.1 | 0.1 | | | |
| (B2) CNT 600 | | | 0.1 | | | | | | |
| (B3) CNT 90 | | | | 0.1 | | | | | |
| (B4)′ CNT 30 | | | | | | | | 0.1 | |
| (C1) | | | | | | | | | |
| PTFE | | | | | | | | | 100 |
| Carbon fiber | | | | | | | | | 15 |
| Filter housing | | | | | | | | | |
| Average fiber length | 130 | 130 | 400 | 60 | 130 | 130 | | 20 | 300 |
| Resistance value MΩ | | | | | | | | | |
| Static eliminating | B | B | B | B | B | B | D | D | B |
| properties | | | | | | | | | |
| Contamination resistance | | | | | | | | | |
| Metal | A | A | A | A | A | A | A | A | D |
| Carbon | B | B | B | B | B | B | B | B | D |
| Charge residual ratio | A | B | A | A | A | A | D | D | A |
| Discharge craters | B | B | B | B | B | B | D | D | B |
| Volume resistivity | A | B | A | A | A | A | | | A |
| | 10² | 10⁴ | 10² | 10³ | 10² | 10² | | | 10¹ |

### INDUSTRIAL APPLICABILITY

The present invention provides a novel filter housing which is a molded body of a fluororesin composition in which carbon nanotubes are dispersed in a fluororesin, wherein the fluororesin composition includes 0.01 to 2.0% by mass of the carbon nanotubes.

The filter housing has excellent antistatic performance and exhibits excellent static eliminating performance while preventing elution of impurities (metal ions, organic substances, etc.).

The present invention can also provide a filter (or filter cassette) including the filter housing and a filter element (or filter medium).

The present invention can also provide a filtration apparatus (or filter apparatus) including the filter, and an apparatus including the filtration apparatus or filter in which a fluid is used, for example, a semiconductor manufacturing apparatus, a liquid crystal manufacturing apparatus, a pharmaceutical manufacturing apparatus, a chemical manufacturing apparatus or the like.

### RELATED APPLICATION

This application claims priority under Article 4 of the Paris Convention on Japanese Patent Application No. 2019-90170 filed on May 10, 2019 in Japan, the disclosure of which is incorporated by reference herein.

### REFERENCE NUMERALS

1 Charge residual ratio evaluation apparatus
2 IN side tube
4 OUT side tube
6 OUT side tube
8 Joint
10 Filter
15 Electrometer

1. A filter housing which is a molded body of a fluororesin composition in which carbon nanotubes are dispersed in a fluororesin,
wherein the fluororesin composition comprises 0.01 to 2.0% by mass of the carbon nanotubes.

2. The filter housing according to claim 1, wherein the carbon nanotubes have an average length of 40 μm or more.

3. The filter housing according to claim 1, which has a volume resistivity of 1×10⁻¹ to 1×10⁶ Ω·cm.

4. A filter comprising the filter housing according to claim 1.

5. A filtration apparatus comprising the filter according to claim 4.

6. A semiconductor manufacturing apparatus, a liquid crystal manufacturing apparatus, a pharmaceutical manufacturing apparatus, a pharmaceutical delivery apparatus, a chemical manufacturing apparatus or a chemical delivery apparatus, each comprising the filtration apparatus according to claim 5.
